(19) United States
(12) Patent Application Publication
(10) Pub. No.: US 2020/0394943 A1
(43) Pub. Date: Dec. 17, 2020

(54) LED-ILLUMINATED CAUTION AND DISPLAY DEVICES

(71) Applicants: Walt Sedlacek, West Chicago, IL (US); Paul Xue Bang Hu, Mississauga (CA)

(72) Inventors: Walt Sedlacek, West Chicago, IL (US); Paul Xue Bang Hu, Mississauga (CA)

(21) Appl. No.: 16/900,654

(22) Filed: Jun. 12, 2020

Related U.S. Application Data
(60) Provisional application No. 62/860,890, filed on Jun. 13, 2019.

(51) Int. Cl. G09F 13/18; G09F 17/00

(52) U.S. Cl. CPC G09F 13/18; G09F 17/00

(57) ABSTRACT

A caution device and a display device are used to draw attention to either a hazardous area, e.g., a construction zone, or a desired event, e.g., a grand opening. The devices are visible during daylight but are also equipped with LEDs to illuminate during twilight, dark, and inclement weather. The devices are preferably reusable.

### RELATED APPLICATION

The present application claims the filing priority of U.S. Provisional Application No. 62/860,890 titled “LED-ILLUMINATED TAPE AND BANNERS” and filed on Jun. 13, 2019. The '890 application is hereby incorporated by reference.

### TECHNICAL FIELD OF THE INVENTION

The present invention relates to tape and banners. More specifically, the invention relates to the type of tape and banners used in public for drawing attention to an area, facility or event that is either a) closed, blocked, hazardous, off-limits, under-construction, or the like, or b) open, celebrating, decorating, or the like.

### BACKGROUND OF THE INVENTION

Barricade (or caution) tape is commonly used to alert pedestrians and motorists to temporarily marked-off areas for a variety of reasons (e.g., construction, hazards, crime scene, work area, security, wet paint, etc.) The tape, which does not necessarily come with an adhesive backing as the name would imply, is generally comprised of black lettering printed on an iconic yellow plastic or fiber material which is approximately 2-4″ wide. However, the tape may come in other colors, each of which may have a specific meaning within a particular field.

The tape is used because it is highly visible during daytime hours. Unfortunately, the material is much less visible during the twilight hours of dawn and dusk, after dark, and during low visibility conditions, such as fog, rain, and snow.

Likewise, pennant flags, or banners, are similarly used to catch people's attention and alert them to a specific area or event. Pennant flags are comprised of a plurality of single or multi-colored flags made of a plastic or fiber material and attached to a line (e.g., string, cord, rope, or the like) so they can be hung in a key high-traffic location, either indoors or outdoors. These pennant flags are typically used where the desire is to catch people's attention and draw them into an area (e.g., sporting event, car dealerships, grand openings, parties, etc.)

Much like the caution tape, pennant flags are highly visible during daylight hours, typically due to the flag color. However, also like the caution tape, that visibility is significantly reduced during dawn, dusk, night and inclement weather.

Referring specifically to the prior art illustrated in FIGS. 1 and 2, examples of display and caution devices are shown which are used to draw attention to an area, facility, event or the like. The caution tape (FIG. 1) is most commonly a bright yellow-colored plastic or fibrous material of about 2 to 4 inches wide with black printing. Generally speaking, the product is used for the purpose of blocking access to an area or building, or just to mark an area as potentially dangerous. Unfortunately, the material, while often brightly colored, can fade from sunlight or become dirty as a result of dust, dirt and pollutants in the air which settle onto the material. These conditions make the tape more difficult to see and, therefore, the hazard more

Conversely, the display banner device (FIG. 2), which is typically comprised of a string of triangular flags or banners, is intended to draw people to an area, building or event. The flag/banner material is typically brightly colored, but like the caution tape, it can lose that bright color as a result of becoming faded and dirty.

As noted, neither of these devices are as visible during dark times (e.g., night, twilight, and inclement weather) as desirable.

Accordingly, a product is needed which has both daytime and nighttime visibility. Until the invention of the present application, these and other problems in the prior art went either unnoticed or unsolved by those skilled in the art. The present invention provides an improved LED-illuminated tape and banner product which accomplishes the desired function for any area, facility or event without sacrificing customization, design, style or affordability.

### SUMMARY OF THE INVENTION

There is disclosed herein improved display and caution devices which avoid the disadvantages of prior devices while affording additional structural and operating advantages.

The disclosed display devices are used for attracting attention to a desired area, facility, event or the like, and comprise a flexible base member comprised of a string, cord, rope, or similar component, a plurality of flag members attached in succession to the base member, and a lighting element fixed to the base member.

The disclosed caution devices are used for alerting people to hazards or the like and comprise a sufficient length of material having a width in the range of from 1 inch (2.54 cm) to 5 inches (12.2 cm), and a lighting element attached to the length of material. The lighting element is comprised of a plurality of lights spaced along the length of the material.

In specific embodiments of each disclosed device, a power source is connected to the lighting element and attached to the device in some known manner. Preferably, the lighting element for each is comprised of a string of LEDs. Preferably, the LEDs are imbedded in the flexible base or material of the device.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 illustrates various embodiments and uses of the prior art which is generically referred to as “caution tape” in commerce;

FIG. 2 illustrates various embodiments and uses of the prior art which is generically referred to as “display banners” in commerce;

FIG. 3A illustrates an embodiment of the display banner device with the LEDs turned off;

FIG. 3B is similar to FIG. 3A except the illustrated embodiment of the display banner device has the LEDs turned on;

FIG. 4A illustrates an embodiment of the caution tape device with the LEDs turned on;

FIG. 4B is similar to FIG. 4A except the illustrated embodiment of the caution tape device has the LEDs turned off;

FIG. 5A is a front view of a section of an embodiment of the disclosed display banner device illustrating the placement of LEDs;

FIG. 5B is a side cross-section of the embodiment of FIG. 5A;

FIG. 6A is a front view of a section of an embodiment of the disclosed caution tape device illustrating the placement of LEDs;

FIG. 6B is a side cross-section of the embodiment of FIG. 6A;

FIG. 7A is a front view of a section of a second embodiment of the disclosed caution tape device illustrating the placement of LEDs;

FIG. 7B is a side cross-section of the embodiment of FIG. 7B;

FIG. 8A is a front view of a section of a third embodiment of the disclosed caution tape device illustrating placement of LEDs; and

FIG. 8B is a side cross-section of the embodiment of FIG. 8A.

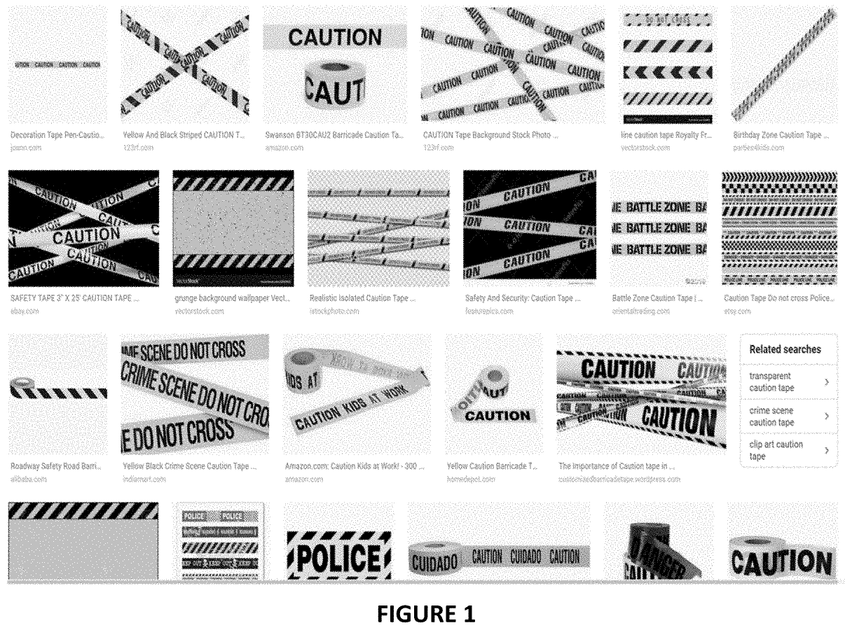

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

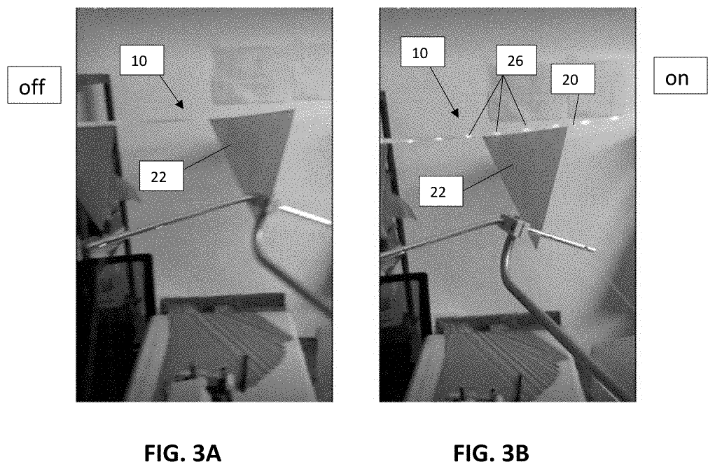

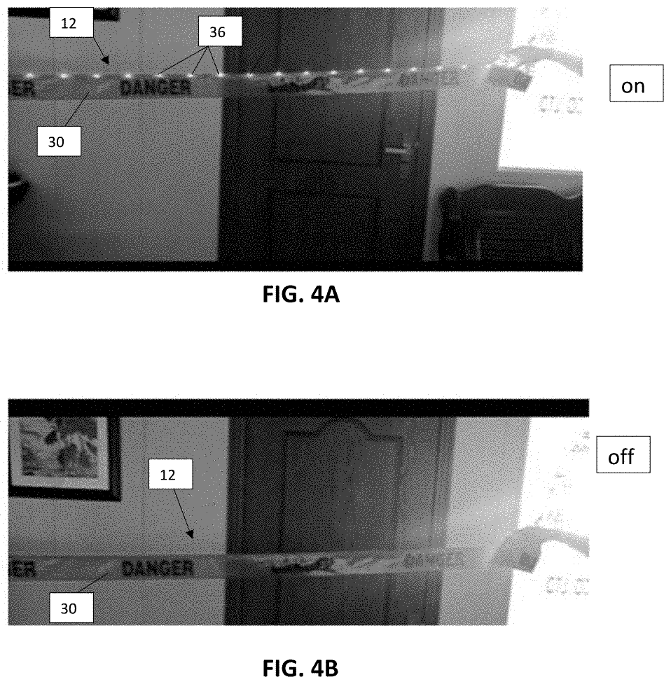

Referring to FIGS. 3-8, embodiments of the banner display device 10 (see FIGS. 3A-B, 5A-B) and caution tape device 12 (see FIGS. 4A-B, 6A-B, 7A-B, 8A-B) are illustrated. Both devices are comprised of a long body portion and a functioning lighting element, as will be explained further below. Preferably, a strand of LEDs is used to provide illumination, but other low-heat lighting sources may be used as well.

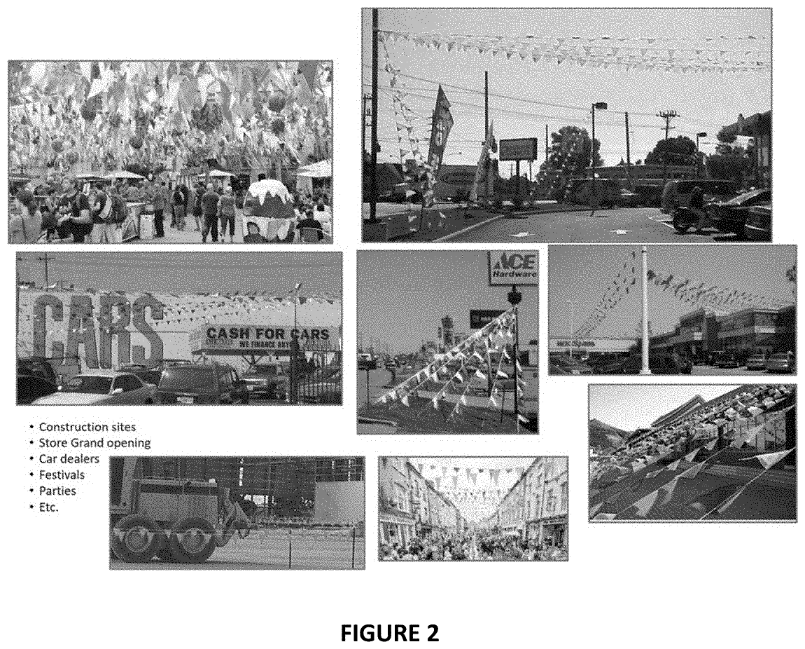

In the case of the banner display device 10, it is comprised of a long plastic strip body 20 to which a plurality of flag/banners 22 are attached in succession. A cord or rope 24 is typically threaded through the plastic strip body 20 to allow ends to be tied off to a structure (e.g., see FIG. 2). These banner displays 10 are well-known in the art.

However, preferably within the plastic strip body 20 a strand of LEDs 26 is inserted. The LEDs 26 may be intermittently placed in regular or irregular intervals, preferably two to eight inches apart. Other spacings may also be suitable for specific uses. The LEDs 26 may only need to be run through a portion of the entire strip body 20, such as the ends or a middle section. The LEDs 26 are preferably connected to a power source (not shown), such as an AC cord or a rechargeable DC battery pack. To conserve power, the LEDs 26 may also be connected to a light-sensor (not shown) which controls power to turn the LEDs 26 on only when visibility is low.

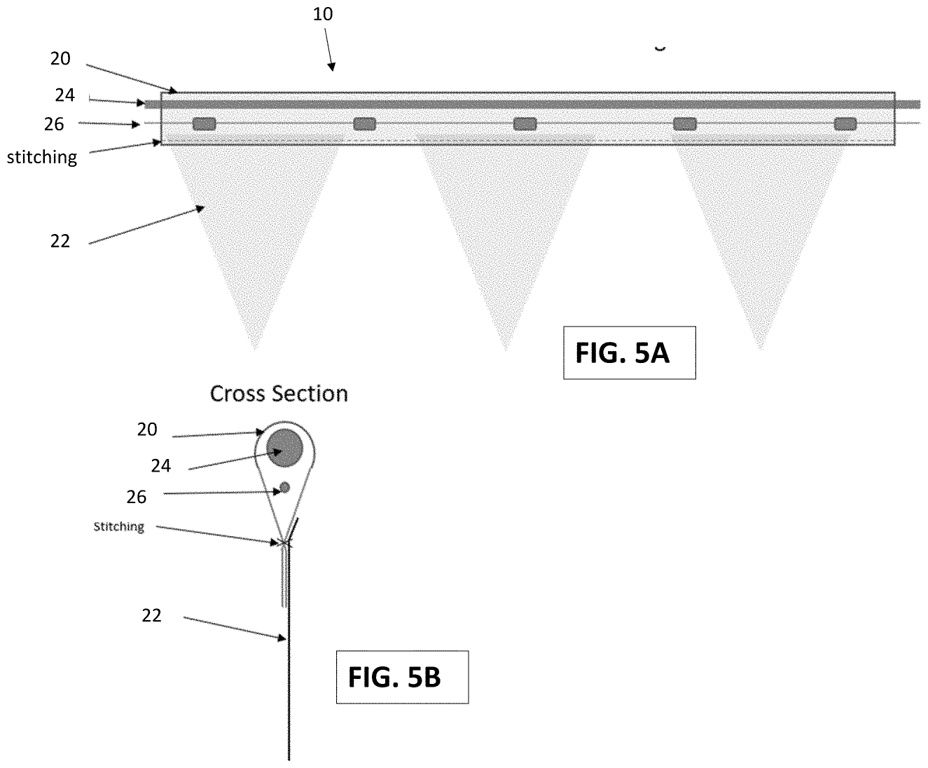

FIGS. 5A and 5B show a preferred construction of the display banner device 10.

Likewise, the caution tape device 12 has a long body 30 comprised of typical caution tape. The tape is typically 2-5 inches wide with black lettering. This general device is also well-known to those skilled in the art.

However, the device 12 of the present invention includes a strand of LEDs 36 spaced along an edge of the tape, as shown in FIG. 4A. The LEDs 36 may be intermittently placed in regular or irregular intervals, preferably two to eight inches apart. Other spacings may also be suitable for specific uses. The LEDs 36 may only need to be run through a portion of the entire body 30, such as the ends or a middle section. The LEDs 36 are preferably connected to a power source (not shown), such as an AC cord or a rechargeable DC battery pack. To conserve power, the LEDs may also be connected to a light-sensor (not shown) which controls power to turn the LEDs on only when visibility is low.

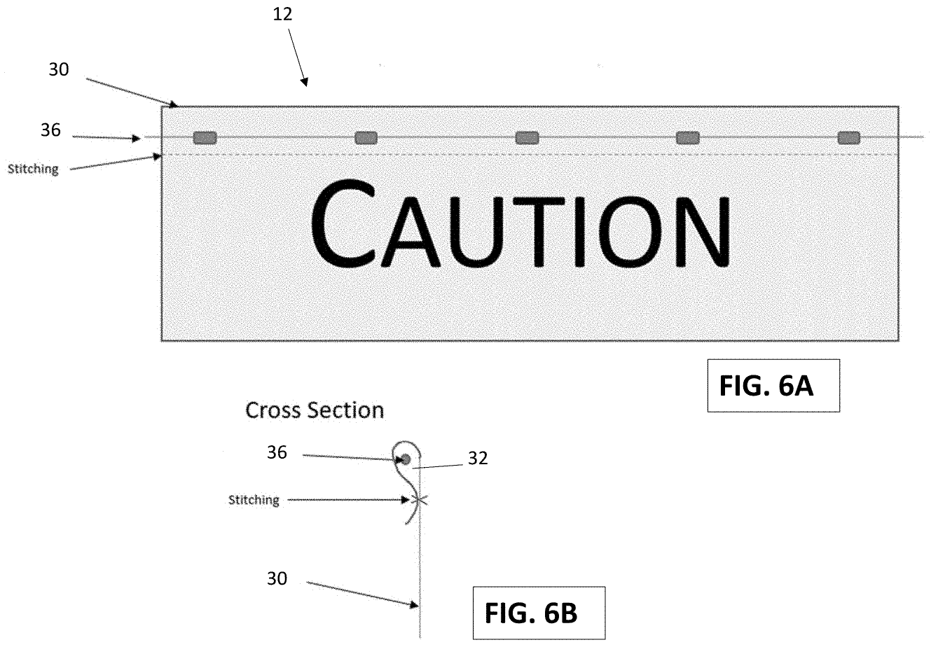

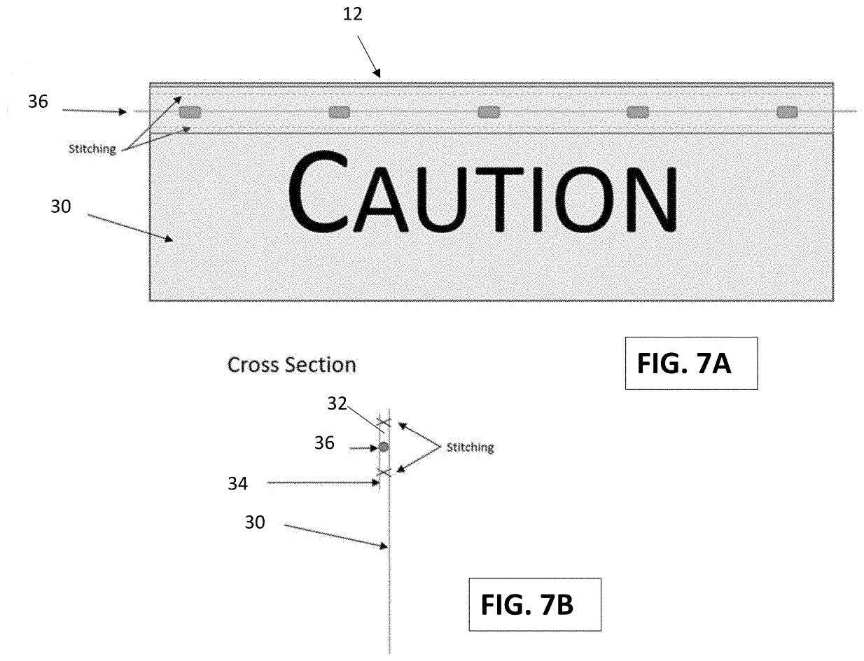

FIGS. 6A and 6B show a first preferred construction of the caution tape device 12. The first embodiment loops a top edge of the tape over and a single line of longitudinal stitching to create a channel 32 for the LED strand 36. Alternatively, FIGS. 7A and 7B show the use of a narrow plastic strip 34 attached to the top edge of the tape with double longitudinal stitching to create a channel 32 for the LED strand 36.

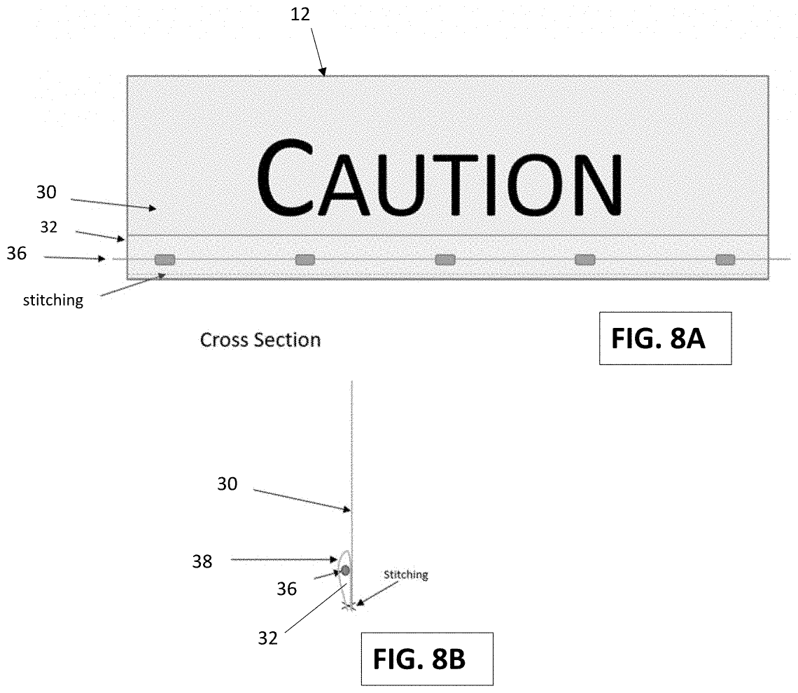

Finally, in another preferred embodiment of the caution tape device, FIGS. 8A and 8B show a bottom-mounting for the plurality of LEDs 36. In this embodiment, a separate material strip 38 is stitched into and along the bottom edge of the body 30 to create a channel 32 for the LED strand 36. In this embodiment, the weight of the LED strand 36 along the bottom of the device helps prevent rolling over of the device 12.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A display device for extending between two stationary structures for the purpose of attracting attention, the display device comprising:
a flexible base member comprised of a string, cord, rope, or similar component;
a plurality of flag members attached in succession to the base member;
a lighting element fixed to and extending along the base member such that the lighting element illuminates at least a portion of the base member; and
a power source coupled to the lighting element.

2. The display device of claim 1, wherein the lighting element comprises a plurality of LEDs spaced along the base member.

3. The display device of claim 2, wherein the LEDs are imbedded in the flexible base.

4. The display device of claim 1, wherein the power source comprises a battery pack or other portable power supply.

5. The display device of claim 2, wherein the LEDs extend along the entire base member.

6. The display device of claim 2, wherein the LEDs extend along at least 50% of the base member.

7. The display device of claim 2, wherein the LEDs are equally spaced along the base member.

8. A caution device for alerting people to hazards or the like, the device comprising:
a length of material having a width in the range of from 1 inch (2.54 cm) to 5 inches (12.2 cm);
a lighting element attached to and extending along at least a portion of the length of material; and
a power source coupled to the lighting element;
wherein the length of material is intentionally colored and marked to alert people to a possible hazard and the lighting element is comprised of a plurality of lights spaced along the length of the material.

9. The caution device of claim 8, wherein the lighting element comprises a plurality of LEDs.

10. The caution device of claim 9, wherein the LEDs are imbedded in the length of material.

11. The caution device of claim 8, wherein the power source comprises a battery pack or other portable power supply.

12. The caution device of claim 9, wherein the LEDs extend along the entire length of material.

13. The caution device of claim 9, wherein the LEDs extend along at least 50% of the length of material.

14. The caution device of claim 9, wherein the LEDs are equally spaced along the length of material.

15. The caution device of claim 8, further comprising a channel fixed to an edge of the length of material, wherein the lighting element is positioned within the channel.

16. The caution device of claim 15, wherein the channel is along a bottom edge of the length of material.
